(19) United States
(12) Patent Application Publication
(10) Pub. No.: US 2020/0072684 A1
(43) Pub. Date: Mar. 5, 2020

(54) Means of transport having a vehicle seat

(71) Applicant: Ford Global Technologies, LLC, Dearborn, MI (US)

(72) Inventors: Frederic Stefan, Aachen (DE); Frank Petri, Erftstadt (DE); Christoph Arndt Dr habil, Moerlen (DE); Uwe Gussen, Huertgenwald (DE)

(73) Assignee: Ford Global Technologies, LLC, Dearborn, MI (US)

(21) Appl. No.: 16/557,647

(22) Filed: Aug. 30, 2019

(30) Foreign Application Priority Data
Aug. 30, 2018 (DE) 102018214731.0

(51) Int. Cl. G01L 1/00; B60N 2/00; G01K 1/02

(52) U.S. Cl. CPC G01L 1/005; G01K 1/024; B60N 2/002

(57) ABSTRACT

The invention relates to a means of transport having a vehicle seat (2), wherein the vehicle seat (2) has a sensor network (8) comprising a plurality of sensor elements (12) arranged in a two-dimensional manner, wherein the plurality of sensor elements (12) are designed to wirelessly interchange data with one another.

The invention relates to a means of transport having a vehicle seat.

The seats for the driver and for the passengers which are installed in means of transport, for example in motor vehicles, are referred to as vehicle seats.

Vehicle seats have an increasing number of additional functions relating, for example, to safety (safety belt or airbag), comfort (air-conditioning and seat adjustments) or health (massage function). This additional information requires additional sensors which are complicated to integrate in the vehicle seat, however, and are expensive to produce.

There is therefore a need to show ways of being able to capture and provide such additional information in a simpler manner.

The object of the invention is achieved by a means of transport having a vehicle seat, wherein the vehicle seat has a sensor network comprising a plurality of sensor elements arranged in a two-dimensional manner, wherein the plurality of sensor elements are designed to wirelessly interchange data with one another.

During operation, the sensor elements form a system comprising elements which communicate with one another. Since this is effected wirelessly, no lines are needed to transmit signals. This reduces the manufacturing outlay. Additional information can therefore be captured and provided in a simpler manner.

According to one embodiment, the sensor elements form a regular sensor array. The positions of the respective sensor elements and the distances between the respective sensor elements are therefore known. This facilitates the evaluation of measurement results and the determination of distributions of the measured values.

According to another embodiment, the sensor elements form an irregular sensor array. The sensor elements can therefore be arranged in a random form during manufacture, which again simplifies manufacture. The positions of the respective sensor elements and the distances between them can be determined in an initialization step of the sensor network.

According to another embodiment, a further plurality of sensor elements arranged in a row form a data-transmitting connection to a control unit. For example, 10 to 20 sensor elements arranged in a row can form a signal line.

According to another embodiment, a further plurality of sensor elements arranged in a two-dimensional manner form a data-transmitting connection to a control unit. The sensor elements in the first layer have the task of capturing and providing measured values, whereas the sensor elements in the second layer are provided for the purpose of transmitting data packets to the control unit. In other words, the sensor elements in the second layer form a data-transmitting connection with an areal extent.

According to another embodiment, the sensor elements are designed to interchange data at least with a directly adjacent sensor element. In order to transmit data, the sensor elements therefore require transmitting devices with only a limited range.

According to another embodiment, the sensor elements are designed for peer-to-peer data interchange. The sensor elements therefore form a sensor network without a central entity. Such a sensor network without a central entity is particularly fail-safe since failure of a central entity does not result in failure of the entire sensor network.

According to another embodiment, the sensor elements are MEMS sensor elements. The sensor elements are therefore a microsystem with optical components, for example laser sources, mirrors and a laser diode. In this case, the sensor elements in the form of MEMS sensor elements have, for example, a cube-shaped basic form with edge lengths of less than 1 mm. The sensor elements can therefore be particularly small and, at the same time, largely autonomous, for example with their own operating energy supply. The sensor elements in the form of MEMS sensor elements may also be considered to be smart dust.

According to another embodiment, the sensor elements are self-organizing. That is to say, the sensor elements make contact with their respective immediate neighbors during an initialization step, interchange the respective identifiers and determine their distance from one another.

The invention also includes a means of transport having such a vehicle seat.

The invention is now explained on the basis of a drawing, in which:

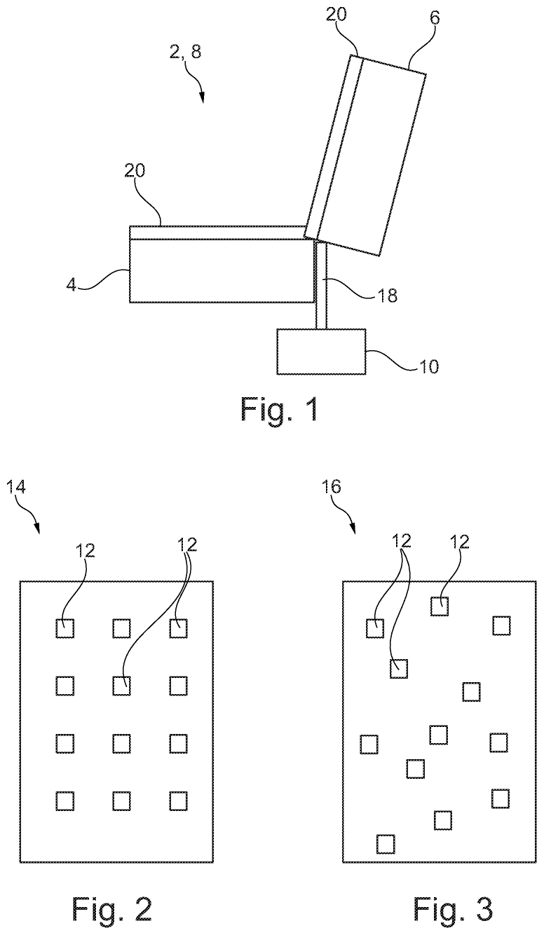

FIG. 1 shows a schematic illustration of a vehicle seat for a means of transport according to a first exemplary embodiment.

FIG. 2 shows a regular sensor array of the vehicle seat shown in FIG. 1.

FIG. 3 shows an irregular sensor array of the vehicle seat shown in FIG. 1.

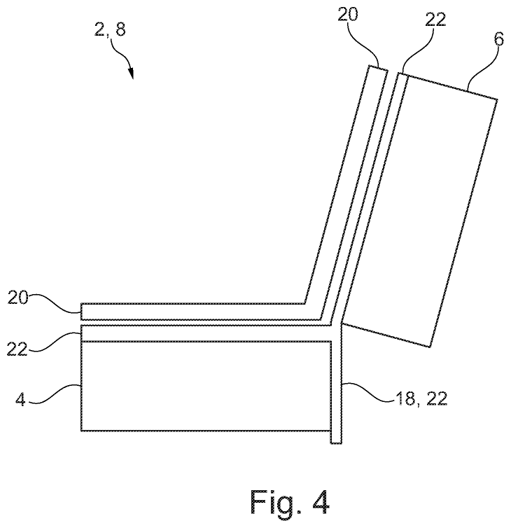

FIG. 4 shows a schematic illustration of a vehicle seat for a means of transport according to a second exemplary embodiment.

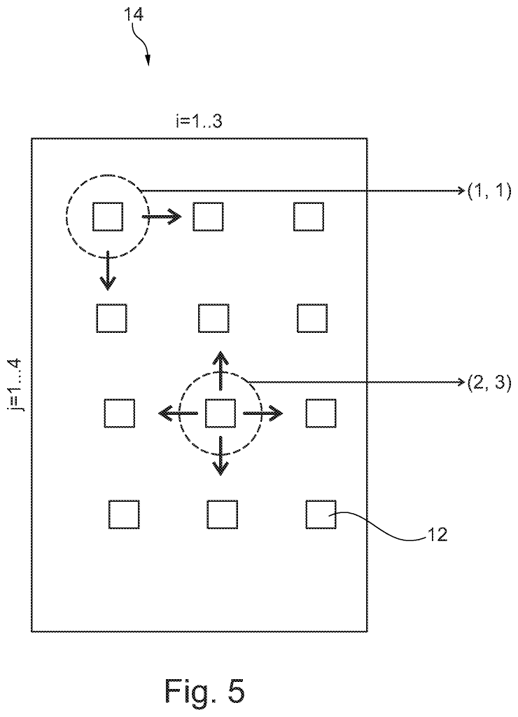

FIG. 5 shows the regular sensor array shown in FIG. 2 during operation.

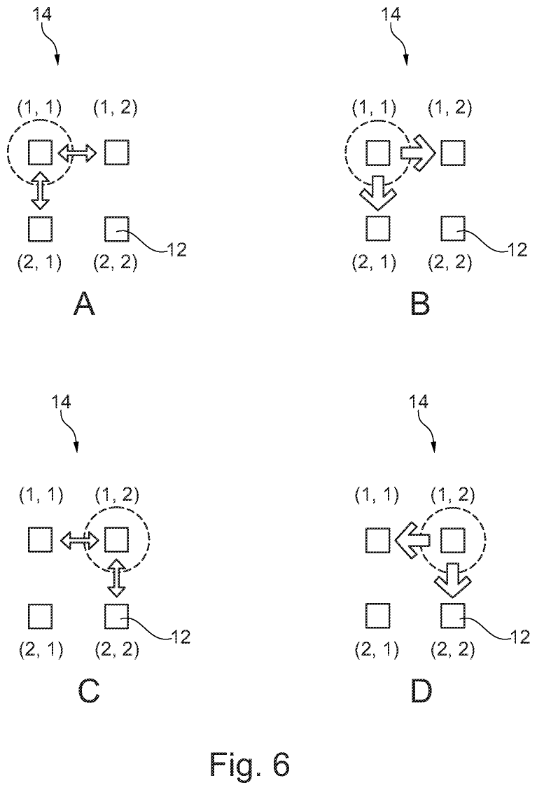

FIG. 6 shows method steps during operation of the sensor array shown in FIG. 5.

Reference is first of all made to FIGS. 1 to 3.

There is an illustration of a vehicle seat 2 of a means of transport. In the present exemplary embodiment, the means of transport is a motor vehicle, for example an automobile. However, the vehicle seat 2 can also be used in other means of transport such as in trains, ships or aircraft. The vehicle seat 2 may be a driver's seat or passenger seat.

The vehicle seat 2 has a seating surface 4 and a backrest 6. In the present exemplary embodiment, a sensor network 8 having a plurality of sensor elements 12 is assigned both to the seating surface 4 and to the backrest 6.

The plurality of sensor elements 12 may form a regular sensor array 14 in which the sensor elements 12 are uniformly spaced apart from one another (see FIG. 2).

Alternatively, the plurality of sensor elements 12 may form a random sensor array 16 in which the sensor elements 12 are spaced apart differently from one another (see FIG. 3).

The sensor elements 12 are connected to a control unit 10 in a data-transmitting manner via a data-transmitting connection 18.

The sensor elements 12 in the region of the seating surface 4 and the backrest 6 are arranged in a two-dimensional manner inside a layer 20, whereas the sensor elements 12 of the data-transmitting connection 18 are arranged in the form of a row behind one another. The sensor elements 12 in the layer 20 are embedded in a flexible material in this case which, for example, through conducts light and/or electromagnetic waves.

The sensor elements 12 are designed to wirelessly interchange data with one another, for example by means of electromagnetic waves or by means of optical signals, for example laser pulses. For this purpose, the sensor elements 12 may have accordingly designed transmitting and receiving units, for example laser sources and laser detectors. Furthermore, the sensor elements 12 may have sensors for capturing temperature and/or pressure, for example.

Furthermore, the sensor elements 12 may have a memory, for example for archiving an identifier of the sensor element 12 and further measured values. In order to be supplied with operating energy, the sensor elements 12 may be designed to obtain electrical energy from oscillations or vibrations or from light. Energy can also be supplied by means of induction. Finally, the sensor elements 12 may have hardware and/or software components for these tasks and/or functions and for tasks and/or functions described below.

In the present exemplary embodiment, the sensor elements 12 are in the form of MEMS sensor elements, for example with a cube-shaped basic form with an edge length of less than 1 mm. In the present exemplary embodiment, the sensor elements 12 are therefore smart dust.

As also explained in detail later, the sensor elements 12 are designed to interchange data with a respectively directly adjacent sensor element 12. For this purpose, the sensor elements 12 are designed to form data packets comprising measured values and the identifier of the respectively transmitting sensor element 12 and to transmit said data packets to the respective adjacent sensor element 12. These data packets then pass, via the sensor elements 12 of the data-transmitting connection 18 which are arranged in the form of a row behind one another, to the control unit 10. In other words, the sensor elements 12 are self-organizing.

Reference is now additionally made to FIG. 4.

The vehicle seat 2 shown in FIG. 4 differs from the vehicle seat 2 shown in FIG. 1 in that a further layer 22 having sensor elements 12 is provided below the layer 20 having the sensor elements 12.

In this case, the sensor elements 12 in the first layer 20 have the task of capturing and providing measured values, whereas the sensor elements 12 in the second layer 22 are provided for the purpose of transmitting the data packets to the control unit 10. In other words, the sensor elements 12 in the second layer form the data-transmitting connection 18.

The sensor elements 12 in the second layer 20 can also be embedded in a flexible material which, for example, through conducts light and/or electromagnetic waves.

Reference is now additionally made to FIG. 5.

FIG. 5 illustrates the fact that, during operation, the sensor element 12 at the position (2, 3) buffers the identifiers of the directly adjacent sensor elements 12 at the positions (2, 2), (2, 4), (1, 3) and (3, 3) and the respective distances between the sensor elements 12 and the measured values provided by the respective sensor elements 12 in its memory.

The control unit 10 is designed to determine, by evaluating these data, a distance distribution of the sensor elements 12, for example, if they form a random sensor array 16. The control unit 10 is also designed to determine, by evaluating these data, a temperature distribution and/or pressure distribution and/or brightness or attenuation distribution as a result of weight-induced attenuation of a light transmission, for example.

Reference is now additionally made to FIG. 6.

In the present exemplary embodiment, the sensor elements 12 interchange data with their respective directly adjacent sensor element 12. The data can be interchanged in an unmonitored or monitored manner in order to thus ensure that all sensor elements 12 involved interchange data. Routines may be provided in order to exclude duplicate transmissions and to update memory contents only when new values are available in order to thus reduce the volume of data to be transmitted. For this purpose, each sensor element 12 may have a complete map of the regular sensor array 14 or of the random sensor array 16.

Owing to a limited communication range, the sensor element 12 at the position (1, 1) will first of all start to interchange data with the closest neighbor in a first step A during operation, wherein it initiates its handshake as part of an initialization step using wireless data transmission in order to obtain the identifier of this neighbor. Only the two sensor elements 12 at the positions (1, 2) and (2, 1) can respond.

After the handshake, the capture of measured values and the interchange of data begin in a further step B. In this case, the sensor element 12 at the position (1, 1) can capture the distances to the sensor elements 12 at positions (1, 2) and (2, 1) with the aid of a light sensor and can measure its temperature. Finally, the sensor element 12 at the position (1, 1) shares these data with the sensor elements 12 at the positions (1, 2) and (2, 1).

In further steps C and D, the sensor element 12 at the position (1, 2) now transmits data to the sensor elements 12 at the positions (1, 1) and (2, 2) (step D) in a similar manner following a further initialization step (step C). After step D, the same data are archived in the respective memories of the sensor elements 12 at the positions (1, 1), (1, 2) and (2, 2). In other words, the respective memory contents have been synchronized.

By means of further steps (not illustrated), data can be interchanged between the sensor elements 12 at the positions (2, 2) and (2, 1) and (1, 2) in order to achieve complete synchronization.

In a manner differing from the present exemplary embodiment, the sensor elements 12 may also implement peer-to-peer data interchange.

During operation, a distance distribution of the sensor elements 12, for example, can be captured using the sensor network 8 and can be transmitted to the control unit 10. If a driver or passenger sits on a vehicle seat 2, the distances between the sensor elements 12 will change. Since these data are recorded over time, 4D mapping of the temporal development of the distance distribution is available.

It is also possible to determine a brightness distribution in order to determine seat load standard values which indicate or do not indicate a seat load. Vehicle status signals such as key status, vehicle speed, door status, seatbelt buckle status, etc. can additionally be concomitantly evaluated. If a plurality of value distributions are close or equal to their respective standard value, for example, the probability of a seat load is zero.

Furthermore, a temperature distribution can also be determined for this purpose.

The data captured and transmitted in this manner can therefore be used, for example, to detect seat occupancy or to optimize an airbag, to identify a driver, to control a seat heating system, to control a seat massage system, to automatically control actuators for adjusting a seat position or to trigger an orthopedic seat function.

For this purpose, captured value distributions can be compared with reference value distributions and a threshold value can be determined on the basis of the comparison of the captured value distributions with the reference value distributions. If the threshold value is exceeded or undershot, corresponding activation or control signals can be generated in order to activate one or more of the above-mentioned functions.

Such additional information can therefore be captured and provided in a simpler manner.

### LIST OF REFERENCE SIGNS

2 Vehicle seat
4 Seating surface
6 Backrest
8 Sensor network
10 Control unit
12 Sensor element
14 Regular sensor array
16 Random sensor array
18 Data-transmitting connection
20 Layer
22 Second layer

1. A vehicle, comprising:
a vehicle seat (2); and
a sensor network (8) disposed within the vehicle seat,
wherein the sensor network comprises a plurality of sensor elements (12) arranged in a two-dimensional manner, wherein the plurality of sensor elements (12) are configured to wirelessly interchange data with one another.

2. The vehicle according to claim 1, wherein the plurality of sensor elements (12) form a regular sensor array (14).

3. The vehicle according to claim 1, wherein the plurality of sensor elements (12) form an irregular sensor array (16).

4. The vehicle according to claim 1, wherein a second plurality of sensor elements (12) arranged in a row form a data-transmitting connection (18) to a control unit (10).

5. The vehicle according to claim 1, wherein a second plurality of sensor elements (12) arranged in a two-dimensional manner form a data-transmitting connection (18) to a control unit (10).

6. The vehicle according to claim 1, wherein the plurality of sensor elements (12) are configured to interchange data at least with a directly adjacent sensor element (12) of the plurality of sensor elements.

7. The vehicle according to claim 1, wherein the plurality of sensor elements (12) are configured for peer-to-peer data interchange.

8. The vehicle according to claim 1, wherein the plurality of sensor elements (12) are MEMS sensor elements.

9. The vehicle according to claim 1, wherein the plurality of sensor elements (12) are self-organizing.

10. A vehicle seat (2), comprising:
a sensor network (8) disposed within the vehicle seat,
wherein the sensor network comprises a plurality of sensor elements (12) arranged in a two-dimensional manner, wherein the plurality of sensor elements (12) are configured to wirelessly interchange data with one another.

11. The vehicle seat according to claim 10, wherein the plurality of sensor elements (12) form a regular sensor array (14).

12. The vehicle seat according to claim 10, wherein the plurality of sensor elements (12) form an irregular sensor array (16).

13. The vehicle seat according to claim 10, wherein a second plurality of sensor elements (12) arranged in a row form a data-transmitting connection (18) to a control unit (10).

14. The vehicle seat according to claim 10, wherein a second plurality of sensor elements (12) arranged in a two-dimensional manner form a data-transmitting connection (18) to a control unit (10).

15. The vehicle seat according to claim 10, wherein the plurality of sensor elements (12) are configured to interchange data at least with a directly adjacent sensor element (12) of the plurality of sensor elements.

16. The vehicle seat according to claim 10, wherein the plurality of sensor elements (12) are configured for peer-to-peer data interchange.

17. The vehicle seat according to claim 10, wherein the plurality of sensor elements (12) are MEMS sensor elements.

18. The vehicle seat according to claim 10, wherein the plurality of sensor elements (12) are self-organizing.
